(19) United States
(12) Patent Application Publication
(10) Pub. No.: US 2011/0107232 A1
(43) Pub. Date: May 5, 2011

(54) Directory and notification system for college students based on individual user profiles

(75) Inventors: Bradley Mark Brody, W. Des Moines, IA (US); Brittany Rachel Brody, W. Des Moines, IA (US)

(73) Assignee: BBE Partners LLC

(21) Appl. No.: 12/925,773

(22) Filed: Oct. 29, 2010

Related U.S. Application Data
(60) Provisional application No. 61/280,180, filed on Oct. 29, 2009.

(51) Int. Cl. G06F 3/01

(52) U.S. Cl. 715/745

(57) ABSTRACT

An Internet (web based) system is adapted for enriching a user's college experience by helping the user discover and keep informed of events, activities, organizations (e.g., clubs), lectures, local businesses (i.e., merchant advertisements) and other matters that may be of particular interest to the user based on a “user interests profile” generated from personal data collected from the user. The system provides a searchable and current directory of events, activities, organizations and other matters of interest to students at a particular university. A notification feature provides updates and reminders to each individual student member (user) through a medium(s) that the user chooses (e.g., email, text messaging, RSS, calendar) to keep informed of events and to suggest other events that might be of interest to the user. The system further supports an advertising mechanism for delivering targeted advertisements of local businesses to particular users based on their specific user interests profiles.

This patent application is based on provisional patent application Ser. No. 61/280,180 filed on Oct. 29, 2009.

### BACKGROUND OF THE INVENTION

1. Field of the Invention

This invention relates to online search and notification systems and, more particularly, to a searchable online directory of events, organizations, etc. and an electronic notification system that informs users of various events, activities, organizations and other matters of interest through various mediums (e.g., member page on system website, email, text messaging, RSS, calendar) based on individual user profiles.

2. Discussion of the Related Art

Adjusting to life on a college campus is a challenge that many students face. In most cases, attending college is the first time young people are away from the daily support network of family and home. Unlike high school, which usually consists of a single building, the vast size (i.e., both acreage and number of buildings) and population of a typical college campus can be overwhelming, particularly to a freshmen student. And, due to a lack of an efficient communication system, even junior and senior college students have a difficult time staying informed of events, activities, organizations, lectures and other matters that may be of interest to a college student. Presently, notices of events, activities, club meetings etc. are made by posting paper flyers on walls, doors, and other structures around campus. In short time, these paper notices are torn down, damaged and/or destroyed. The event or organization identified in the notice may be of interest to only a small fraction of the campus population, and often those persons who may have had an interest in attending the event, meeting, etc. may never see the posted flyer. Moreover, even those interested students who read the flyer may subsequently forget the posted date, time and location of the event and will, thus, fail to attend. The lack of an effective search, notification and calendaring system for campus events, activities, organizations, lectures, local businesses and other matters of individual personal interest limits the ability of students to experience all that college life has to offer.

Accordingly, there remains a definite need for an Internet based system that is designed to enrich the user's college experience by helping the user discover and keep informed of events, activities, organizations, lectures and other matters of particular interest to each specific user of the system.

### OBJECTS AND ADVANTAGES OF THE INVENTION

Considering the foregoing, it is a primary object of the present invention to provide a web based application with a searchable and current directory of events, activities, organizations, lectures and other matters of interest to students at a particular university.

It is a further object of the present invention to provide a web based application having a notification system that provides updates and reminders through a medium(s) that the user chooses (e.g., member page of the system website, email, text messaging, RSS, calendar) allowing the user to keep informed of campus events, organizations, activities, lectures and other matters of interest to the user.

It is still a further object of the present invention to provide a web based application that creates a user interests profile for each user of the system, thereby allowing the system to suggest events, activities, organizations, etc. that may be of particular interest to a specific user.

It is still a further object of the present invention to provide a mechanism for advertisers to target delivery of relevant ads to college students based on current user profiles.

It is still a further object of the present invention to provide a web based application for allowing organizations on a college campus to deliver messages (e.g., email, text messages, etc.) to college students and others on campus who may have a specific interest in the organization based on their unique user interests profile.

It is still a further object of the present invention to provide an Internet system, as set forth above, which includes web based applications for inputting, searching and retrieving data from a system database.

It is still a further object of the present invention to provide an electronic search and notification system, as described above, with export capabilities for popular calendaring systems that college students are accustomed to using.

These and other objects and advantages of the present invention are more readily apparent with reference to the following detailed description and accompanying drawing.

### SUMMARY OF THE INVENTION

The present invention is directed to a web based (World Wide Web) system that is particularly adapted for enriching a user's college experience by helping the user discover and keep informed of events, activities, organizations (e.g., clubs), lectures, local businesses (i.e., merchant advertisements) and other matters that may be of particular interest to the user based on the user's preferences in a “user interests profile” generated from personal data collected from the user. The system provides a searchable and current directory of both “on campus” and “off campus” events, activities, organizations and other matters of interest to students at a particular university. The events and activities in the directory may be arranged according to user selected methods, such as “most popular” or by price or date. A notification feature provides updates and reminders to each individual student member (user) through a medium(s) that the user chooses (e.g., member page on the system website, email, text messaging, RSS, calendar) to keep informed of events and to suggest other events that might be of interest to the user. The user can connect with friends on the system via a linked social networking web-based system such as FACEBOOK® or MYSPACE®. The system further supports an advertising mechanism for delivering targeted advertisements of local businesses to particular users based on their unique user interest profiles. A calendaring function allows students to organize their classes, daily schedule, activities, club meetings, events, etc. The system automatically inserts selected events of interest in the user's calendar. The calendaring function has export capabilities to other external calendaring systems.

### BRIEF DESCRIPTION OF THE DRAWINGS

For a fuller understanding of the nature of the present invention, reference should be made to the following detailed description taken in conjunction with the accompanying drawing in which:

FIG. 1 is a block diagram that illustrates the functions and processing of the system of the present invention.

Like reference numerals refer to like parts throughout the several views of the drawings.

### DETAILED DESCRIPTION OF THE PREFERRED EMBODIMENT

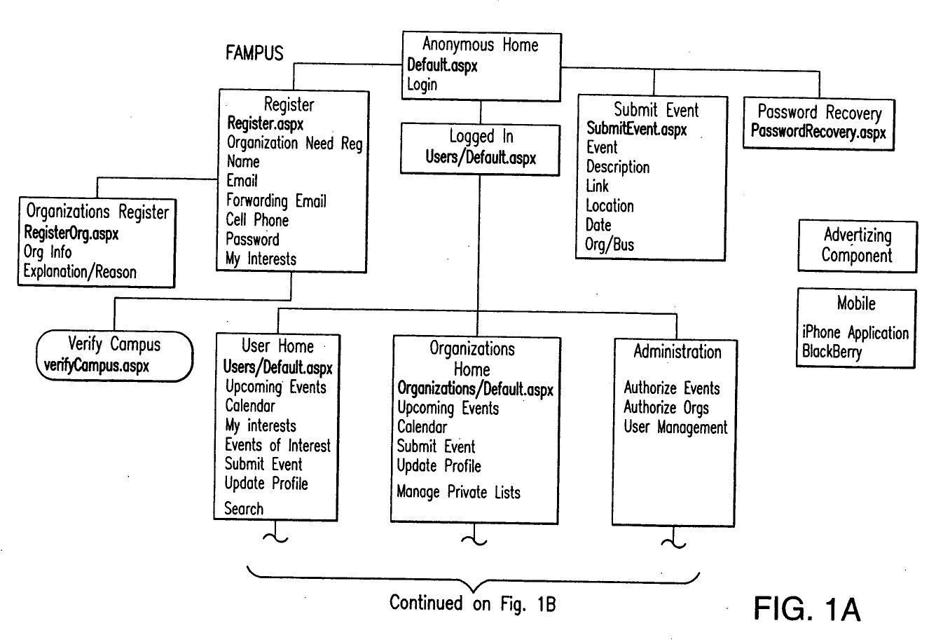

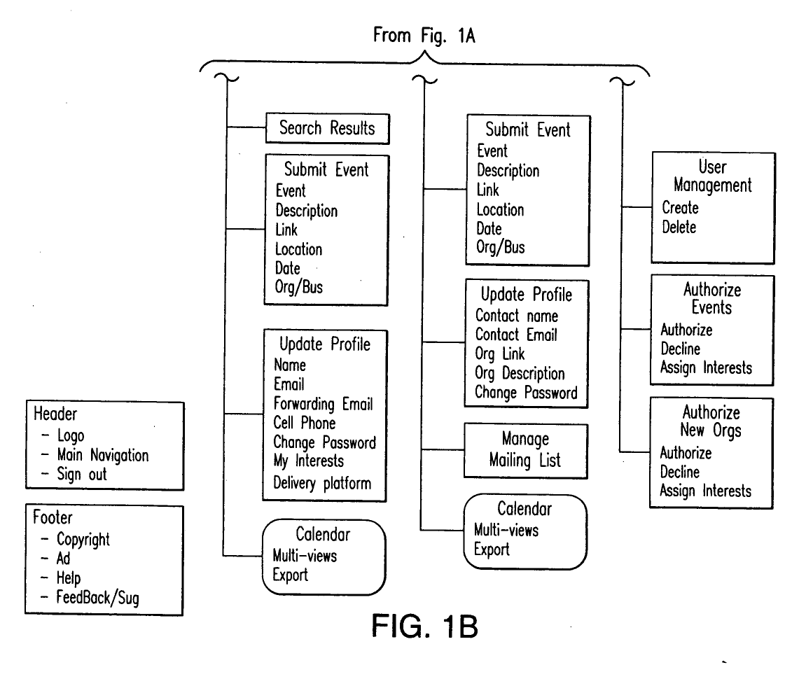

The searchable social networking, directory and notification system of the present invention is shown in the functional block diagram of FIG. 1. The system utilizes a web (World Wide Web) server. In one preferred embodiment, the system database resides on the web server along with software for rotating ads and tracking statistics such as impressions and click-through rates. The system supports multiple applications including, but not limited to, a user interface, a staff interface, an organization interface, an advertiser interface and a mobile phone application (Blackberry, iPhone). All applications are web based.

The user interface provides an anonymous homepage that directs new users to register and existing users (members) to login. The homepage will detect if the user is currently logged in. If the user is logged in, they are sent to the user's homepage (account). The anonymous homepage further provides the login function, as well as a “Forgot My Password” function, a “Register” option, and a video/flash intro explaining the benefits of the system and why one should become a registered user or organization. From the anonymous homepage, new users are directed to a registration page. Additionally, organizations wishing to register are directed to an organizations registration page. Upon registering, organizations must provide information about the organization along with an explanation or reason for joining the system. All organizations are reviewed and pre-approved (authorized) by the system administration.

Individual users register by providing their name, email address, forwarding email, cell phone number, iPhone/Blackerry and a selected password (with a password reentry function for confirmation). Upon registering, new users are instructed to input their specific interests for the purpose of building a “user interests profile.” The new user is also presented with a list of all student clubs/organizations that are registered with the system. For security purposes, the system compares the user email with the college email system. If the email provided by the new user doesn't match, the system presents required additional fields for entry including: reason wanting access; and a pull down menu to choose a college. A new user will not have access until approved by the system administration.

From the anonymous homepage, organizations, individual users and the system administration are able to login. Login requires entry of a username and password. Upon logging in, individual users are directed to a user homepage. At the user homepage, the user has the selection of various functions that may include any of the following:
Upcoming Events and Coupons
Calendar
View my Events (selected)
My Interests and Preferences
Events of Interest (scrollable window)
Connect with your Friends
Pending Friend Requests
Submit Event
Profile Information
Update Profile
Change Password
Search

Selecting “Upcoming Events” scrollable window will present the user with all upcoming campus and university related events (e.g., those upcoming events within the next 30-60 days) that may be of interest to the particular user based on the user's interests profile. The user can then select any of these events which will then be automatically entered into the user's calendar. The system will automatically remind the user of the upcoming selected event at several points in the time prior to the event. This can be done by reminders being sent to the user by various mediums of the user's choice including email, text messaging, RSS and calendar.

Selecting the “Calendar” function on the user's homepage will present the user with the user's personal calendar showing all scheduled events, lectures, club meeting dates, scheduled activities and other matters of interest that have been selected by the user. The user can modify the calendar by deleting any events, activities, etc. and/or adding new events, activities, meeting dates etc.

Selecting “View My Events” will present a listing of all of the events and activities that the user has previously selected. These selected events and activities may be arranged according to date and time (i.e., chronologically) or in order of preference by the user.

Selecting “My Interests and Preferences” on the user homepage presents the user with a list of preferences that may be categorized, such as according to the following categories:
Events Around Town
Events on Campus
Clubs and Organizations
Music, Performing and Visual Arts
Restaurants, Bars and Shopping
Sports and Recreation
University Athletic Events
Speakers and Discussions
Religious and Spiritual

The user can select any one or more items under each of these categories to build a “User Interests Profile.”

Selecting the “Events of Interest” scrollable window on the user homepage directs the user to a listing of all upcoming events that may be of particular interest to the user based on the unique “user interests profile” of that particular user. The user can then select any of these events of interest which will be automatically inputted on the user's calendar and added to the list of Upcoming Events. Reminders will be sent to the user by the selected method(s) at several times prior to the event.

The user can connect with friends on the system by clicking on “Connect with your Friends” which initially presents a list of the user's friends that have agreed to socialize using the system. The user can then click on any of the friends which will then connect the user to the selected friend via a′ linked social networking web-based system such as FACEBOOK® or MYSPACE®.

The user can invite new friends by locating the individuals on the system and sending them an invitation to be on their “Friends List.” By clicking on “Pending Friend Requests” the user can view the invitations from others on the system asking the user to be a Friend on the system.

The user may select “Submit Event” on the user homepage to submit a particular event that the user may be hosting. This will require the user to submit the name of the event, a description of the event, a click-on link to the event, as well as a location of the event and a location link. The user is also instructed to insert the start time, end time and date of the event. After submitting an event, the system administration must review and approve the event. Upon approval, the system administration assigns the interests categories to the event for directing to all user members having a “user interests profile” that matches the event. This may be done by word match software and/or by system administration.

The user can also conduct a search from the user homepage. The search may be conducted by organizations, interests, event titles and other keywords and categories. For example, entering the search term “Football” may return the following:
(User's University) NCAA Football Games
Intramural Football
Kappa Alpha's Powder Puff Football Game
The play “Two Daisies for one Football”

The user may also select “Update Profile” on the user homepage. This allows the user to perform such functions as:
Change Password
Modify Interests
Modify Delivery Platform for reminders, etc (email, text messaging, RSS, Calendaring)
Modify Phone Number
Modify Name
Modify Forwarding Email

Once organizations have registered and have been approved by the system administration, they are able to login through the anonymous homepage using the chosen password. After an organization has logged in, the organization will be directed to the organizations homepage. The organizations homepage presents the following choices:
Upcoming Events
Calendar
Submit Event
Update Profile
Manage Private Lists

Selecting “Upcoming Events” presents the organization with a list of all the organizations upcoming campus and university related events. The organization can then select any of these events if it desires to edit or delete the specific selected event.

Selecting the “Calendar” function on the organization's homepage will present the organization with the organization's calendar showing all scheduled events, club meeting dates, schedules activities and other matters of interest that have been scheduled by the organization. The organization can modify its calendar by deleting any events, activities, etc. and/or adding new events, activities, meeting dates, etc.

The organization can select “Submit Event” on the organization's homepage to submit a particular event. This will direct the organization to the “Submit Event” page. At the “Submit Event” page, the organization is directed to enter the following information:
Event Name
Event Description
Event Link
Location of the Event
Date of the Event
Name of the Organization/Business

At the organization's homepage, an organization may select “Update Profile” for changing various information. This will direct the organization to a “Update Profile” page presenting the following choices for updating or modifying the organizations profile:
Contact Name
Contact Email
Organization Link
Organization Description
Change Password

At the organization's homepage, an organization can manage its private mailing lists. By selecting “Manage Private Lists”, the organization is directed to the “Manage Private Lists” page where the organization can perform the following functions:
Import Private Mailing List
View Private Mailing List
Add Private Mailing List
Edit Private Mailing List

An organization will further have the ability to manage its events by adding a new event, editing the information for a previously submitted event, modifying the organization description and/or changing the organization link for a specific event or events.

After an organization submits an event, the system administration must review and approve the event. Upon approval, the system administration assigns the interests categories to the event for directing notification of the event to all user members having a “user interests profile” that matches the event. This may be done by keyword match software and/or system administration oversight.

The staff interface is accessible to only system administration personnel and provides the ability to manage and view information on the system. The staff interface requires login by system administration personnel with use of an assigned password. Staff access can be varied among system administration personnel with full staff access allowing access to all administrative functionality and sub staff access being limited to “view only access” to the administrative system and the ability to search the system database.

After logging in, administrative personnel are directed to the administration page on the system. With full staff access, the administrative personnel have access to the following:
Authorize Events
Authorize Organizations
User management
The administrator has the ability to add new users to capture and store the user information as detailed in the user section.

Under the user management function, the administrator also has the ability to edit existing users, unlock a user's account, delete one user at a time and search for existing users by name, email address or alphabetically. The search results for any users will present the administrator with the username, name (last, first) and email address of the user.

The system administrator authorizes or declines all submitted events from both users and organizations. When an event is authorized, the administrator assigns “interests” categories to the event. This can be achieved with the use of keyword matching software and/or system administrator oversight.

The administrator further authorizes or declines all organizations desiring to register with the system.

A smart phone application can be downloaded and installed on the user's smart phone or similar type portable electronic device that provides Internet access. All logins using this application happen on the same page with the following limitations:
User has ability to see Upcoming Events, Events of Interest and User has the ability to add an Event of Interest to their Upcoming Events

The user interface will include the following pages:
Login
User Home
   Upcoming Events
   Events of Interests

The advertiser interface uses Internet ad serving software or rotation software for rotating ads and tracking statistics. All advertisers on the system are required to login.

While the present invention has been shown and described in accordance with a preferred and practical embodiment thereof, it is recognized that departures from the instant disclosure are contemplated within the spirit and scope of the present invention.

What is claimed is:

1. A web-based social networking and notification system comprising:
at least one computer server connected to the World Wide Web global computer network, and said at least one computer server including a system database and a plurality of web-based software applications communicating with said system database, said plurality of web-based software applications including a user interface, a staff interface and an organization interface that are accessible using computer devices connected to the World Wide Web global computer network;
said user interface supporting a system homepage specific to a user geographic community, and said system homepage providing a register function for directing new users of the system to a register page for collecting information from the new users in order to register the new users with the system, and said homepage further providing a login function for directing existing users to their personal user homepage on the system;
said system being structured and disposed for collecting and storing user specific data for each registered user on the system database, including user specific personal interests and preferences, to establish a user profile for each registered user based on each user's personal interests and preferences;
said system being further structured for storing information relating to events, activities, organizations and businesses in the user geographic community, and said system being structured and disposed for presenting the information relating to the events, activities, organizations and businesses on the system homepage;
said system being further structured and disposed for comparing each individual registered user's user profile with the stored information relating to the events, activities, organizations and businesses and matching particular events, activities, organizations and businesses to each individual registered user based on the collected personal interests and preferences of each registered user's user profile;
said system being further structured and disposed for presenting the stored information for the matched particular events, activities, organizations and businesses on each registered user's user homepage as suggested events, activities, organizations and businesses that may be of particular interest to each registered user based on each user's specific user profile;
said system being further structured and disposed for allowing each registered user to select any of the events, activities, organizations and businesses from both a suggested list based on the user's specific user profile and from a general directory listing all events, activities, organizations and businesses in the system database;
said system being further structured and disposed for presenting all upcoming events and activities, as well as organizations and businesses selected by a registered user on that registered user's user homepage;
said system being further structured and disposed for notifying each registered user of upcoming events and activities, as well as organizations and businesses that may be of interest to each specific registered user based on the user's specific user profile; and
said system being further structured and disposed for reminding each registered user of upcoming events, activities and meetings of organizations that have been selected by the user.

2. The system as recited in claim 1 wherein the system is further structured and disposed for connecting registered users to other registered users for communicating via the World Wide Web global computer network.

3. The system as recited in claim 2 wherein the system is further structured and disposed for allowing each registered user to identify other registered users on the system as friends, and further wherein the system is structured and disposed for allowing each registered user to view the selected events, activities, organizations and businesses of the registered user's friends.

4. The system as recited in claim 3 wherein the system is further structured and disposed for arranging and presenting upcoming events and activities on the homepage for each registered user based on the popularity of each upcoming event and activity.

5. The system as recited in claim 4 wherein the system is further structured and disposed for indicating to each registered user the number of friends of the registered user that have selected any of the events, activities, organizations and businesses on the system.

6. The system as recited in claim 5 wherein the system is further structured and disposed to alert each registered user concerning business specials and advertisements of businesses in the geographic community, including providing the registered user with coupons for businesses in the geographic community, based on a match of any particular business stored in the system to the personal interests and preferences in the registered user's individual user profile.

7. A social networking, directory and notification method comprising the steps of:
providing at least one computer server connected to the World Wide Web global computer network, and said at least one computer server including a system database;
providing a plurality of web-based software applications installed on the at least one computer server;
providing a user interface for communicating with the at least one computer server and wherein the user interface is accessible using a computer device connected to the World Wide Web global computer network and providing a system homepage on said user interface that is specific to a user geographic community;
providing a register function on said system homepage and directing new users of the system to a register page for collecting information from the new users in order to register the new users;
providing a login function on said system homepage for directing previously registered users to a personal user homepage;
collecting and storing user specific data for each registered user on the system database, including user specific personal interests and preferences, and establishing a user profile for each registered user based on each registered user's personal interests and preferences;
storing information relating to events, activities, organizations and businesses in the user geographic community;
presenting the information relating to the events, activities, organizations and businesses on said system homepage;
comparing each individual registered user's user profile with the stored information relating to the events, activities, organizations and businesses and matching particular events, activities, organizations and businesses to each individual registered user based on the collected personal interests and preferences of each registered user's user profile;
presenting the stored information for the matched particular events, activities, organizations and businesses on each registered user's user homepage and suggesting to the registered user that the matched particular events, activities, organizations and businesses may be of particular interest to the registered user based on the registered user's specific user profile;
allowing each registered user to select any of the events, activities, organizations and businesses from a suggested list based on the registered user's specific user profile and from a general directory listing of all events, activities, organizations and businesses in the user's geographic community that have been previously stored;
presenting upcoming events and activities, as well as organizations and businesses selected by a registered user on the registered user's user homepage;
notifying each registered user of upcoming events and activities as well, as organizations and businesses that may be of interest to each specific registered user based on the registered user's specific user profile; and
reminding each registered user of upcoming events, activities and meetings of organizations that have been previously selected by the registered user.

8. The method as recited in claim 7 further comprising the step of:
connecting registered users to other registered users for communicating via the World Wide Web global computer network.

9. The method as recited in claim 8 further comprising the step of:
allowing each registered user to identify other registered users on the system as friends, and allowing each registered user to view the selected events, activities, organizations and businesses of the registered user's friends.

10. The method as recited in claim 9 further comprising the step of:
arranging and presenting upcoming events and activities on the homepage for each registered user based on the popularity of each upcoming event and activity.

11. The method as recited in claim 10 further comprising the step of:
indicating to each registered user the number of friends of the registered user that have selected any of the events, activities, organizations and businesses in the general directory listing.

12. The method as recited in claim 11 further comprising the step of:
alerting each registered user concerning specials and advertisements of businesses in the community, and providing the registered user with coupons for businesses in the geographic community based on a match of a business to the personal interests and preferences in the registered user's individual user profile.
